(19) United States
(12) Patent Application Publication
(10) Pub. No.: US 2011/0216227 A1
(43) Pub. Date: Sep. 8, 2011

(54) METHOD FOR ADJUSTING IMAGE PICKUP DEVICE AND IMAGE PICKUP DEVICE

(75) Inventor: Kazushige Ikeda, Sakai-shi (JP)

(73) Assignee: Konica Minolta Opto, Inc., Hachioji-shi, Tokyo (JP)

(21) Appl. No.: 13/128,312

(22) PCT Filed: Nov. 6, 2009
(86) PCT No.: PCT/JP2009/068972

§ 371 Date: May 9, 2011

(30) Foreign Application Priority Data
Nov. 12, 2008 (JP) 2008-289626

(51) Int. Cl. H04N 5/217

(52) U.S. Cl. 348/241; 348/E05.078

(57) ABSTRACT

Provided is a method for adjusting an image pickup device, wherein a position of an image pickup element is set to an initial position, a uniform luminance surface is picked up, a luminance distribution on an image pickup surface is calculated, whether data of the luminance distribution on the four corners of the image pickup surface substantially agree with each other or not is judged, and such operations are repeated until the data substantially agree with each other by moving the position of the image pickup element by a predetermined value. By using the position of the image pickup element obtained when the data substantially agree with each other as information of the center position, the center position of the image pickup element can be adjusted in a short time and an image having a natural luminance distribution can be obtained.

### TECHNICAL FIELD

The present invention relates to a method for adjusting an image pickup device and to the image pickup device. In particular, the present invention relates to a method for adjusting an image pickup device equipped with a blur correcting means and the image pickup device.

### BACKGROUND ART

This is the heyday of a digital camera employing a blur correcting function for correcting blur resulting from camera shake held by hands or blur resulting from a subject movement, by moving a CCD-type or COMS type of image pickup element within a surface perpendicular to the optical axis of an image pickup optical system, or by moving one or plural optical elements in the image pickup optical system within a surface perpendicular to the optical axis of the image pickup optical system. It is essential for such the digital camera to adjust an initial position of the center of an image pickup area of the image pickup element, corresponding to the position of a subject image formed by the image pickup optical system.

As a method for adjusting the initial position of the center of the image pickup area, for example, Patent Literature 1 discloses: (1) a method to move an image pickup element to positions such that the image pickup element protrudes from an image circle in three directions, to obtain information of the center position of the image circle from the protruded amounts, namely the eclipse amounts, and thereby to make the center of the image circle agree with the center of the image pickup area; and (2) a method to obtain the center of distribution of a shading characteristic of an image acquired by the image pickup element, and to make the center of distribution of shading characteristics agree with the center of the image pickup area.

Further, Patent Literature 2, for example, discloses a method that, in a process of forming an image by using partial information from the image pickup element, namely a trimming process, an image frame on the image pickup element is defined such that the light amount in the image frame is uniform.

### CITATION LIST

### Patent Literature

Patent Literature 1: JP-A No. 2004-545581
Patent Literature 2: JP-A No. 2001-257930

### SUMMARY OF INVENTION

### Technical Problem

However, in the method (1) of Patent Literature 1, the obtained image becomes unnatural when the shading characteristic is asymmetrical with respect to the center of the image circle, which is a problem. Further, the method requires that the image pickup element is moved at least three times. Moreover, it requires setting the movement amount of the image pickup element to be large such that the eclipse is caused in every type of image-pickup optical system. When the movement amount is large, some kinds of image-pickup-element position sensors cause increased errors. In the method, after the center position of the image circle is obtained at a rough estimate by carrying out the movements three times, the measurement is carried out again from the obtained center position with the reduced movement amount. It takes much adjustment time, which is a problem.

Further, in the method (2) of Patent Literature 1, even when the center of distribution of the shading characteristic agrees with the center of the image pickup element, the actual shading characteristic is not always uniform around the center because of a production error of the image pickup optical system. As the result, the difference in luminance is caused on four corners of the image area, resulting in an unnatural image, which is a problem.

Further, in the method of Patent Literature 2, the trimming process is carried out on the assumption that there is provided an image pickup element with the greater number of pixels than the number of actual pixels used for an image pickup processing. Therefore, it requires an expensive and larger image pickup element, which causes a problem of increasing cost and size of a camera.

The present invention has been achieved in view of the above situations, and is aimed to obtain a method for adjusting an image pickup device, whereby the center position of the image pickup element can be adjusted in a short time and an image with natural luminance distribution can be obtained.

### Solution to Problem

An object of the present invention is achieved by the following structures.

1. A method for adjusting an image pickup device, the image pickup device comprising:

an image pickup optical system for forming a subject image;

an image pickup element arranged at an image-forming position of the image pickup optical system and comprising an image pickup surface, for picking up the subject image formed on the image pickup surface by the image pickup optical system; and

a blur correcting means for correcting blur of the subject image formed on the image pickup surface, by moving relative positions of an optical axis of the image pickup optical system and the image pickup element, within a surface perpendicular to the optical axis,

wherein when an image is picked up, a position of the image pickup element is defined based on information of a center position which has been obtained previously, the method for adjusting the image pickup device characterized by comprising:

an initial position moving step of moving the position of the image pickup element to an initial position;

an image pickup step of picking up a uniform luminance surface at the initial position and converting an image of the uniform luminance surface into image signal;

a luminance-distribution calculating step of calculating a luminance distribution on the image pickup surface based on the image signal obtained in the image pickup step;

a center-shift-information calculating step of calculating information of a center shift based on information of the luminance distribution on four corners of the image pickup surface;

a center-agreement judging step of judging whether data of the luminance distribution on the four corners of the image pickup surface almost agree with each other, based on the information of the center shift; and

a center-position-information recording step of obtaining a position of the image pickup element under a condition that the data of the luminance distribution on the four corners of the image pickup surface almost agree with each other, based on a result of the center-agreement judging step, and of recording the position of the image pickup element in the image pickup device as information of a center position.

2. The method for adjusting the image pickup device of the above item 1, characterized in that

the information of the center shift comprises information of a horizontal direction Δx and information of a vertical direction Δy which satisfy the following expressions,

where x₁, x₂, x₃, and x₄ are positions of pixels of the image pickup surface in horizontal rows and are named in order of a clockwise direction from an upper left side as the positions are viewed from a side of the image pickup optical system, wherein the pixels have luminance being smaller than a maximum value of the luminance distribution by a predetermined percentage and are positioned on upper and lower ends of the image pickup surface,

y₁, y₂, y₃, and y₄ are positions of pixels of the image pickup surface in vertical columns and are named in order of a clockwise direction from a upper left side as the positions are viewed from the side of the image pickup optical system, wherein the pixels have luminance being smaller than the maximum value of the luminance distribution by a predetermined percentage and are positioned on right and left ends of the image pickup surface,

Iₓ is a length in the horizontal direction of the image pickup surface, and

I_{y} is a length in the vertical direction of the image pickup surface:

Δx=((x₁+x₃)/2+(x₂+x₄)/2)×½−Iₓ/2,

Δy=((y₁+y₃)/2+(y₂+y₄)/2)×½−I_{y}/2.

3. The method for adjusting the image pickup device of the above item 1 or 2, characterized in that the blur correcting means comprises: an image-pickup-element moving section for moving the image pickup element within the surface perpendicular to the optical axis; and an image-pickup-element position sensor for measuring a position of the image pickup element, and

the initial position is a center position of a measuring range of the image-pickup-element position sensor.

4. The method for adjusting the image pickup device of the above item 1 or 2, characterized in that

the blur correcting means comprises: an image-pickup-optical-system moving section for moving a part or whole of the image pickup optical system within the surface perpendicular to the optical axis; and an image-pickup-optical-system position sensor for measuring a position of the part or whole of the image pickup optical system, and

the initial position is a center position of a measuring range of the image-pickup-optical-system position sensor.

5. The method for adjusting the image pickup device of the above item 1 or 2, characterized in that the initial position is a center value of a data distribution of the center positions which have been obtained previously.

6. An image pickup device comprising:

an image pickup optical system for forming a subject image;

an image pickup element arranged at an image-forming position of the image pickup optical system and comprising an image pickup surface, for picking up the subject image formed on the image pickup surface of the image pickup element; and

a blur correcting means for correcting blur of a subject image formed on the image pickup surface, by moving a relative positions of an optical axis of the image-pickup optical system and the image pickup element, within a surface perpendicular to the optical axis, the image pickup device characterized by further comprising

a recording section,

wherein the recording section records information of a center position obtained by the method for adjusting the image pickup device of any one of the above items 1 to 5.

### Advantageous Effects of Invention

According to the present invention, there can be provided a method for adjusting an image pickup device, wherein a position of an image pickup element is set to an initial position, a uniform luminance surface is picked up, a luminance distribution on an image pickup surface is calculated, whether data of the luminance distribution on the four corners of the image pickup surface substantially agree with each other or not is judged, and such operations are repeated until the data of the luminance distribution substantially agree with each other by moving the position of the image pickup element by a predetermined value. The center position of the image pickup element can be adjusted in a short time by using, as information of the center position, the position of the image pickup element obtained when the data of the luminance distribution substantially agree with each other, and an image having a natural luminance distribution can be obtained.

### BRIEF DESCRIPTION OF DRAWINGS

FIG. 1 is a schematic view for illustrating a digital camera equipped with a blur correcting means.

FIG. 2 is a schematic view illustrating an optical image of a subject formed through an image pickup optical system.

FIG. 3 is a block diagram illustrating an example of an adjusting system for obtaining information of the center position.

FIG. 4 is a flowchart illustrating an embodiment of a method for adjusting a digital camera.

FIG. 5 is a schematic view of an example of luminance distribution on image pickup surface 5a of image pickup element 5.

FIG. 6 is a flowchart for illustrating an inspection of a distribution of light amount at the periphery and a method for coping with failure caused in the inspection.

### DESCRIPTION OF EMBODIMENTS

Hereinafter, the present invention will be described on the basis of an illustrated embodiment. However, the scope of the present invention is not limited to the embodiment. Further, the same number will be assigned to the same or similar portions in the drawings, and the duplicated descriptions will be omitted in some cases.

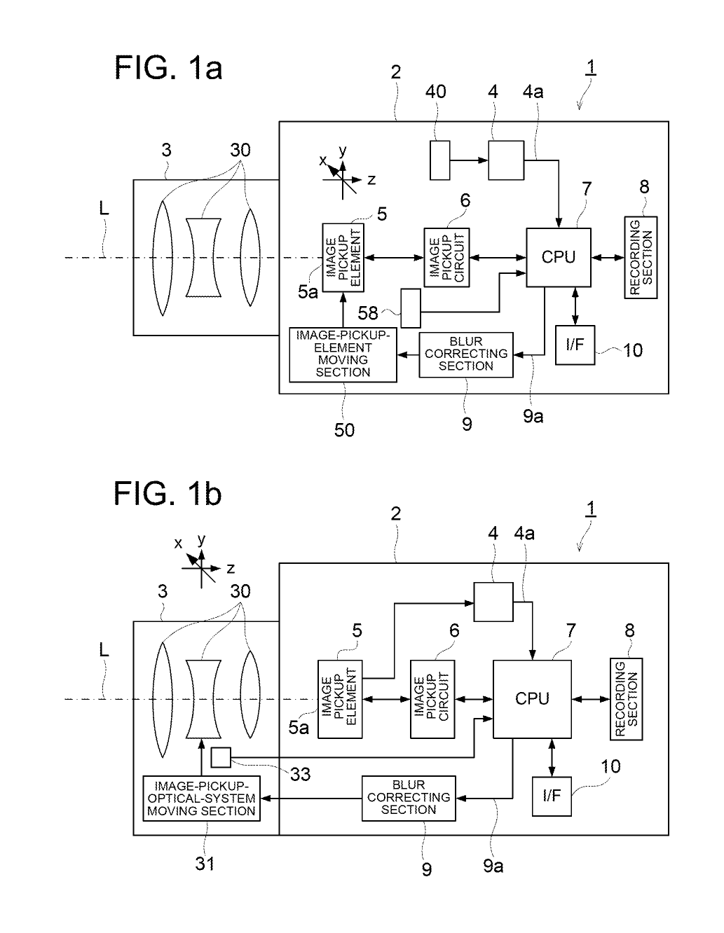

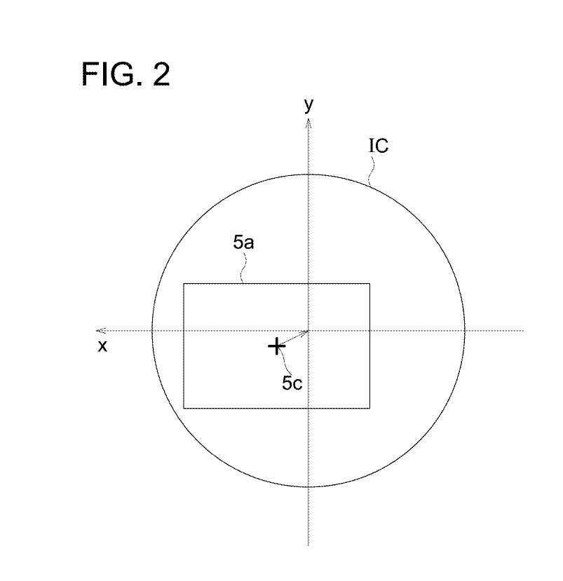

First, a digital camera as an example of an image pickup device equipped with a blur correcting means, to which the present invention is applied, will be described with referring to FIGS. 1 and 2. FIG. 1 is a schematic view for illustrating a digital camera equipped with a blur correcting means. FIG. 1a shows an example of a digital camera equipped with a blur correcting means which employs a type of moving an image pickup element, and FIG. 1b shows an example of a digital camera equipped with a blur correcting means which employs a type of moving an image pickup optical system. FIG. 2 is a schematic view illustrating an optical image of a subject formed through an image pickup optical system.

In FIGS. 1a and 1b, digital camera 1 is composed of camera body 2 and image pickup optical system 3. In camera body 2, there are provided blur detecting section 4, image pickup element 5, image pickup circuit 6, CPU 7, recording section 8, blur correcting section 9, and interface (I/F) 10. Signal from various functions in digital camera 1 is inputted to CPU 7, and the functions of digital camera 1 work under the control of CPU 7.

Image pickup optical system 3 includes lens group 30 composed of a plurality of lenses. As shown in FIG. 2, an optical image of a subject formed through image pickup optical system 3 is formed in an almost circular shape on the x-y plane (hereinafter, an image-forming plane) where the image is formed, which is called an image circle IC. A rectangular area 5a shown in FIG. 2 is image pickup surface 5a of image pickup element 5, and the center of image pickup surface 5a is represented by 5c.

In the example of FIG. 1a, there are further provided image-pickup-element moving section 50, image-pickup-element position sensor 58, and blur detecting sensor 40, additionally to the above structural components in camera body 2. Blur detecting sensor 40, blur detecting section 4, CPU 7, blur correcting section 9, image-pickup-element moving section 50, and image-pickup-element position sensor 58 work as a blur correcting means in the present invention.

In the example of FIG. 1b, there are further provided image-pickup-optical-system moving section 31, image-pickup-optical-system position sensor 33 in image pickup optical system 3. Image pickup element 5, blur detecting sensor 4, CPU 7, blur correcting section 9, image-pickup-optical-system moving section 31, and image-pickup-optical-system position sensor 33 work as a blur correcting means in the present invention.

In the following descriptions, directions and orientations are shown by properly using the x-y-z three-dimensional orthogonal coordinate system shown in the drawings.

The z-axis direction is a direction extending along optical axis L of image pickup optical system 3, and the positive direction of the z-axis points to the destination where an incident light enters (points the right-hand side in the drawings). The y-axis direction is a direction perpendicular to the ground when digital camera 1 is held in the normal position and the positive direction of the y-axis points vertically upward (upward in the drawings). The x-axis direction is a horizontal direction corresponding to the ground when digital camera 1 is held in the normal position and the positive direction of the x-axis points vertically downward toward the figure (the surface of the sheet). Those x, y, and z axes are relatively fixed with respect to digital camera 1.

In the example of FIG. 1a, vibration resulting from shaking of digital camera 1 by hands is detected by blur detecting sensor 40 such as an angular velocity sensor, and the vibration detected by blur detecting sensor 40 is converted into blur signal 4a with blur detecting section 4 and the signal is inputted to CPU 7.

CPU 7 moves image pickup element 5 to the center position based on information of the center position recorded in recording section 8. After that, CPU 7 generates blur correction signal 9a based on blur signal 4a, drives image-pickup-element moving section 50 through blur correcting section 9, and moves image pickup element 5 in the x-y plane which is perpendicular to optical axis L, to correct blur. The movement amount of image pickup element 5 is sensed by image-pickup-element position sensor 58, is inputted to CPU 7, and is used to feedback to the movement control of image pickup element 5.

On the other hand, in the example of FIG. 1b, blur signal 4a is generated by blur detecting section 4 based on a change in time of an image pickuped by image pickup element 5, for example, and the signal is inputted to CPU 7. CPU 7 moves a part of optical elements constituting image pickup optical system 30 or the whole of image pickup optical system 30 to the center position, based on information of the center position recorded in recording section 8.

Next, CPU 7 generates blur correction signal 9a based on blur signal 4a, drive image-pickup-optical-system moving section 31 through blur correcting section 9, and moves the part of optical elements constituting image pickup optical system 30 or the whole of image pickup optical system 30 within the x-y plane which is perpendicular to optical axis L, to correct the blur. The movement amount of image pickup optical system 30 is measured by image-pickup-optical-system position sensor 33, is inputted to CPU 7, and is used to feedback to the movement control of image pickup optical system 30.

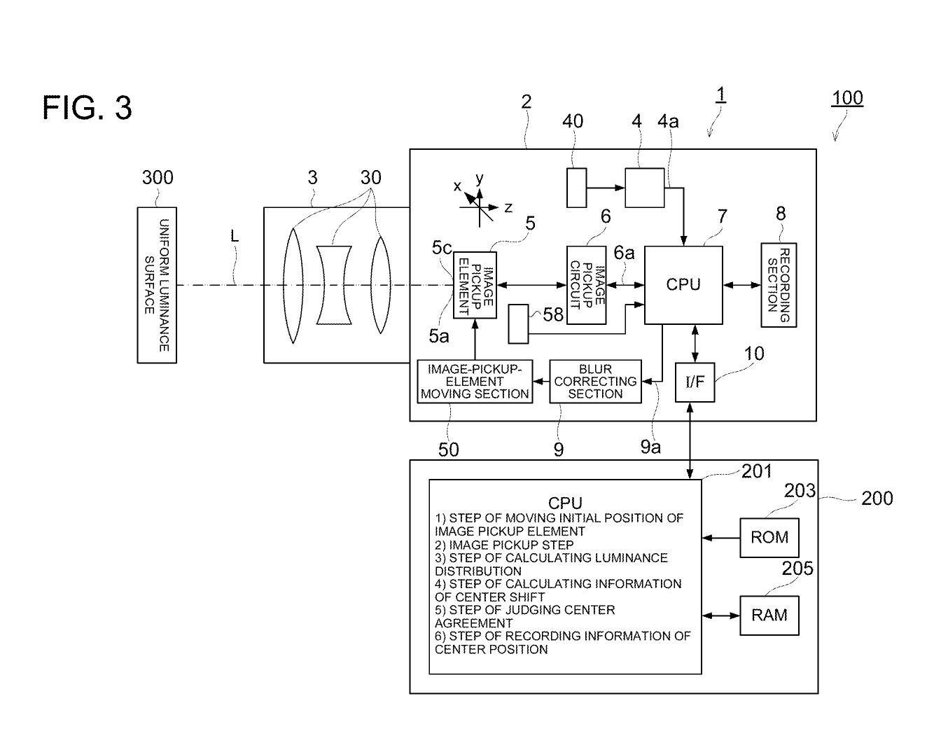

Next, an embodiment of a method for adjusting digital camera 1 which is an example of an image pickup device of the present invention will be described with referring to FIGS. 3 to 5. FIG. 3 is a block diagram illustrating an example of adjusting system 1 for obtaining information of the center position.

FIG. 3 employs an example shown in FIG. 1a for digital camera 1, but that shown in FIG. 1b can be similarly used.

In FIG. 3, adjusting system 100 is composed of adjusting device 200 and uniform luminance surface 300. Adjusting device 200 is composed of CPU 201, ROM 203, and RAM 205. Programs installed in ROM 203 are expanded on RAM 205 and executed by CPU 201. Uniform luminance surface 300 is a surface with a uniform luminance, which has a predetermined brightness, such as a light source box and a white chart.

Image pickup optical system 3 of digital camera 1 is arranged to face uniform luminance surface 300, and forms an image of uniform luminance surface 300 on image pickup surface 5a of image pickup surface 5. The image of uniform luminance surface 300 on image pickup surface 5a of image pickup surface 5 is picked up by image pickup element 5, and is converted into image signal 6a in image pickup circuit 6. The converted signal is inputted to CPU 7. Image signal 6a is transmitted from CPU 7 to CPU 201 of adjusting device 200 through I/F 10.

In CPU 201, processing to obtain information of the center position is carried out based on image signal 6a received from CPU 7.

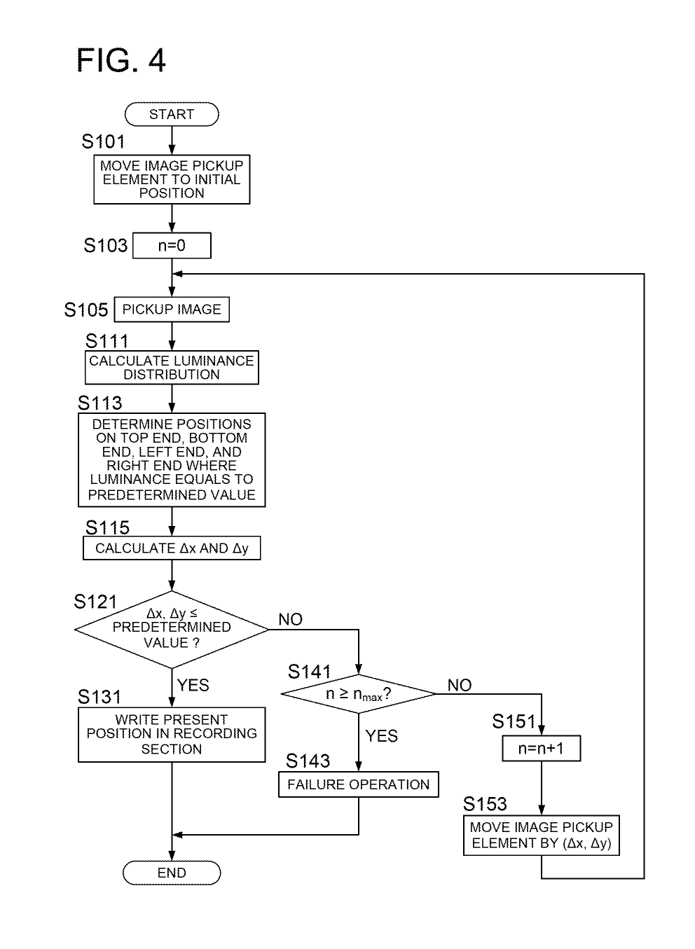

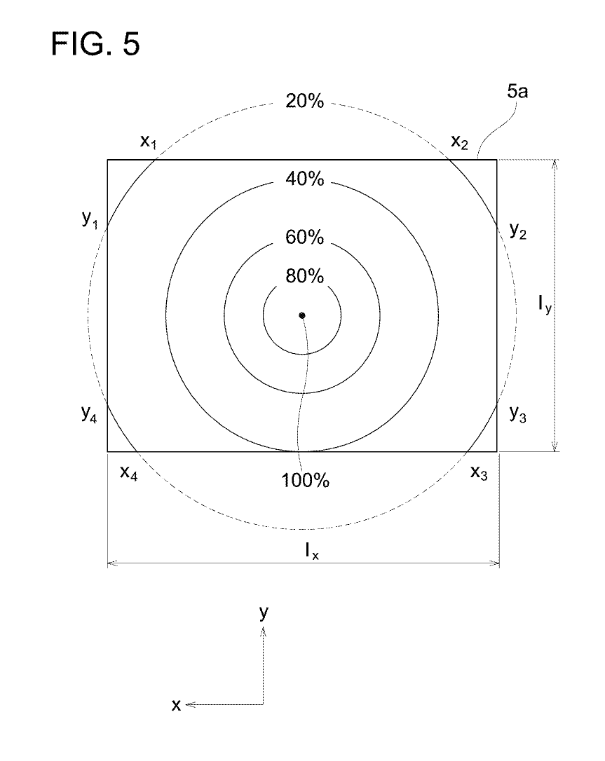

Next, an example of the processing to obtain information of the center position will be described with referring to FIGS. 4 and 5. FIG. 4 is a flowchart illustrating an embodiment of the method for adjusting digital camera 1. FIG. 5 is a schematic view of an example of luminance distribution on image pickup surface 5a of image pickup element 5. In the present embodiment, the uniform luminance surface is picked up, and the position of the image pickup element under the condition that data of luminance distribution on four corners of the image pickup surface almost agree with each other is defined to be the center position.

In step S101 (initial position moving step) in FIG. 4, image pickup element 5 is moved to the initial position. The initial position is the starting point of image-pickup-element position sensor 58 for measuring the position of image pickup element 5, namely, the center position of the measuring range. Under the assumption that digital camera 1 is made up totally according to design values, it is the position where center 5c of image pickup surface 5a of image pickup element 5 agrees with optical axis L of image pickup optical system 3.

In step S103, counter n is reset to zero. In step S105 (image pickup step), an image is picked up with image pickup element 5 and is converted into image signal 6a in image pickup circuit 6, then, image signal 6a is transmitted to CPU 201 through CPU 7 and I/F 10.

In step 111 (luminance-distribution calculating step), luminance distribution on image pickup surface 5a of image pickup element 5 is calculated, based on image signal 6a. For example, it is assumed that the luminance distribution on image pickup surface 5a is a distribution such that luminance gradually reduces from a point exhibiting the maximum luminance (100%) to be 80%, 60% and so on, to form almost concentric circles, as shown in FIG. 5.

In step S113, positions on the four corners of image pickup surface 5a of image pickup element 5 are defined, where each of the positions exhibits the predetermined luminance value, for example, 20% of the maximum luminance, as shown in FIG. 5. Positions of pixels of the image pickup surface 5a in horizontal rows are represented by x₁, x₂, x₃, and x₄ in order of the clockwise direction from the upper left side as the positions are viewed from a side of the image pickup optical system 3, as shown in FIG. 5, where the pixels have 20% of the maximum luminance and are positioned on upper and lower ends of the image pickup surface. Similarly, positions of pixels of the image pickup surface in vertical columns are represented by y₁, y₂, y₃, and y₄ in order of the clockwise direction from the upper left side as the positions are viewed from a side of the image pickup optical system 3, where the pixels have 20% of the maximum luminance and are positioned on left and right ends of the image pickup surface. The predetermined luminance value is properly defined based on specifications of digital camera 1 and characteristics of image pickup optical system 3.

In step S115, information of the center shift Δx in the horizontal direction and information of the center shift Δy in the vertical direction are calculated based on the following expressions, where Iₓ is a length in the horizontal direction of the image pickup surface 5a, and I_{y} is a length in the vertical direction of the image pickup surface 5a.

Δx=((x₁+x₃)/2+(x₂+x₄)/2)×½−Iₓ/2,

Δy=((y₁+y₃)/2+(y₂+y₄)/2)×½−I_{y}/2.

Step S113 and step S115 correspond to the center-shift-information calculating step of the present invention.

In step S121 (center-agreement judging step), it is confirmed whether both of information of the center shift Δx in the horizontal direction and information of the center shift Δy in the vertical direction are the predetermined value or less. When the both values of Δx and Δy are the predetermined value or less (step S121; Yes), positional information 58a of image-pickup-element position sensor 58 which represents the current position of image pickup element 5 is written into recording section 8 as information of the center position in step S131 (center-position-information recording step), and the operations are completed.

When any one of the values of Δx and Δy exceeds the predetermined value (step S121; No), it is confirmed in step S141 whether counter n is equal to or is larger than maximum value nₘₐₓ. When it is equal to or larger than the maximum value (step S141; Yes), the information of center shift is considered not to be converged even after the adjustment is repeated many times. Then, a failure operation is carried out in step S143 and the operations are completed. The value of nₘₐₓ and the way to carry out the failure operation can be properly chosen corresponding to the adjusting system.

When counter n is smaller than maximum value nₘₐₓ (step S141; No), counter n is increased by one in step S151, and image pickup element 5 is moved by the information of the center shift (Δx, Δy). Next, the method returns to step S105 and the above operations are repeated after that. When any one of the values of Δx and Δy is larger than the predetermined value (for example, only the value of Δx is larger than that), the image pickup element may be moved, based on only the larger one (for example, Δx), by the information of the center shift (for example, by Δx).

As described above, according to the present embodiment, the uniform luminance surface is picked up with the image pickup element and the position of the image pickup element under the condition that the data of luminance distribution of the image pickup surface on the four corners almost agree with each other is determined as the center position. Thereby, the center position of the image pickup element can be adjusted in a short time and an image with natural luminance distribution can be obtained because the data of luminance distribution of the image pickup surface on the four corners almost agree with each other.

Other than the starting point of image-pickup-element position sensor 58, the center value of data distribution of information of the center positions obtained in a past can be set to the above-described initial position in step S101. It allows adjustment for obtaining information of the center position, with considering an error of an actual positional relationship between optical axis L of digital camera 1 and image pickup element 5. Thereby, the provability that the adjustment is completed at the initial position becomes great, and adjustment time is aimed to be saved.

Further, in step S113, there is considered the condition that luminance distribution on image pickup surface 5a is so distorted that the positions, which exhibit the predetermined luminance value, on the four corners of image pickup surface 5a of image pickup element 5 cannot be determined, even after image pickup element 5 is moved to the initial position. Under the condition, step S103 and the succeeding operations may be carried out after the center position of distribution of shading characteristics the whole of image pickup surface 5a of image pickup element 5 is obtained by calculation and center 5c of image pickup surface 5a of image pickup element 5 is moved to the position.

Thereby, even when the optical axis of image pickup optical system 3 is greatly shifted from the design value, the position of the four corners of image pickup surface 5a can be determined by starting the adjustment from the center position of distribution of shading characteristics.

The adjustment for obtaining information of the center position was carried out under the condition that digital camera 1 was completed in the above embodiment. However, the adjustment for obtaining information of the center position may be carried out under the situation that there is provided an image pickup unit wherein image pickup element 5, image-pickup-element position sensor 58 and image-pickup-element moving section 50 are attached to image pickup optical system 3, and the unit may be installed to camera body 2.

In this case, instead of writing information of the center position in recording section 8, for example, the information may be printed in bar code to be stuck on the image pickup unit, and then, the information of the center position may be read-out from the bar code and be written in recording section 8 inside camera body 2 when the image pickup unit is installed to camera body 2.

Thereby, it saves time and man-hour required to disassembling and reassembling digital camera 1 when, for example, the adjustment for obtaining information of the center position is not carried out because of defective assembly.

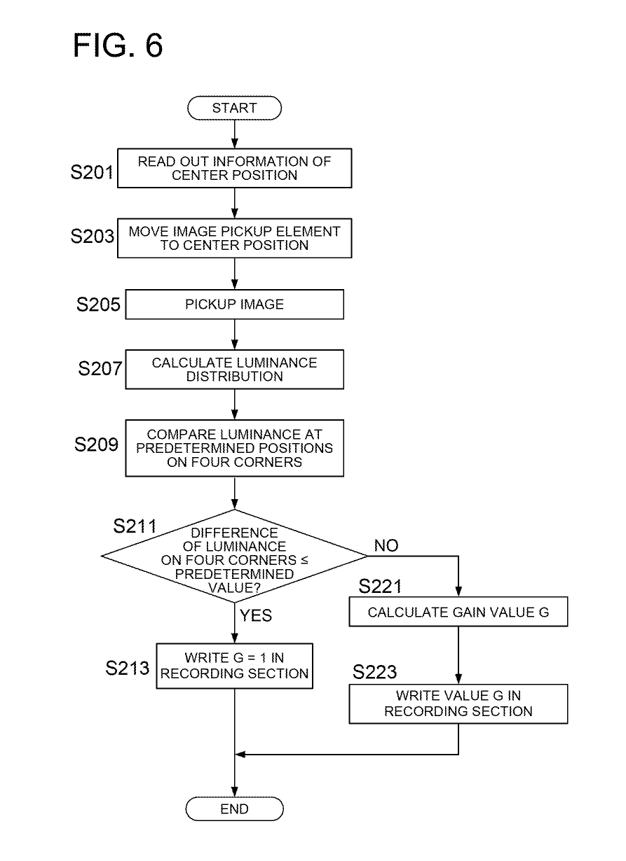

Next, an inspection of the light amount at the periphery obtained after the adjustment for obtaining information of the center position is completed, and the method to handle the case that failure is caused in the inspection will be described with referring to FIG. 6. FIG. 6 is a flowchart for illustrating an inspection of a distribution of light amount at the periphery and a method for coping with failure caused in the inspection.

An inspecting equipment used for the inspection of the light amount at the periphery can be the same one as the adjusting system for obtaining information of the center position shown in FIG. 3.

In FIG. 6, information of the center position which has been recorded in recording section 8 of digital camera 1 is read out in step S201. In step 203, image pickup element 5 is moved to the center position according to the information of the center position which has been read out in step 201.

In step 205, an image is picked up with image pickup element 5 and is converted into image signal 6a in image pickup circuit 6, then, image signal 6a is transmitted to CPU 201 through CPU 7 and I/F 10.

In step S207, luminance distribution on image pickup surface 5a of image pickup element 5 is calculated based on image signal 6a. In step S209, luminance data at the predetermined positions on the four corners of image pickup surface 5a of image pickup element 5, are compared with each other.

In step 211, it is confirmed whether the difference in luminance at the predetermined positions on the four corners of image pickup surface 5a is the predetermined value or less. When the difference is the predetermined value or less (step S211; Yes), information of gain “G=1” is written in recording section 8 in step S213 and the operations are completed.

When the difference in luminance at the predetermined positions on the four corners of image pickup surface 5a is greater than the predetermined value (step S211; No), gain G to make the difference in luminance at the predetermined positions of the four corners of image pickup surface 5a to the predetermined value or less, is calculated in step S221. In step S223, the value of gain G calculated in step S221 is written in recording section 8, and the operations are completed.

When signal processing is carried out in digital camera 1 for the image signal which has been actually picked up by digital camera 1, the image signal is multiplied by the value of gain G which has been written in recording surface 8.

Accordingly, even when image pickup element 5 is moved to the center position indicated by the information of the center position which has been obtained by the method for adjusting digital camera 1 shown in FIG. 4, when the difference in luminance distribution is caused on image pickup surface 5a because of machine difference between the adjusting device and inspection equipment, the difference can be corrected.

As described above, according to the present invention, there can be provided a method for adjusting an image pickup device, wherein a position of an image pickup element is set to an initial position, a uniform luminance surface is picked up, a luminance distribution on an image pickup surface is calculated, whether data of the luminance distribution on the four corners of the image pickup surface substantially agree with each other or not is judged, and such operations are repeated until the data of the luminance distribution substantially agree with each other by moving the position of the image pickup element by a predetermined value. The center position of the image pickup element can be adjusted in a short time by using, as information of the center position, the position of the image pickup element obtained when the data of the luminance distribution substantially agree with each other, and an image having a natural luminance distribution can be obtained.

As for the detailed constructions and detailed operations in respective constitutions constituting the method for adjusting an image pickup device and the image pickup device, it is to be understood that changes and variations may be made properly without departing from the spirit or scope of the present invention.

### CITATION LIST

1 Digital camera
2 Camera body
3 Image pickup optical system
30 Lens group
31 Image-pickup-optical-system moving section
33 Image-pickup-optical-system position sensor
4 Blur detecting section
40 Blur detecting sensor
5 Image pickup element
5a Image pickup surface (of image pickup element 5)
5c Center (of image pickup surface 5a of image pickup element 5)
50 Image-pickup-element moving section
58 Image-pickup-element position sensor
6 Image pickup circuit
7 CPU
8 Recording section
9 Blur correcting section
10 Interface (I/F)
100 Adjusting system
200 Adjusting device
201 CPU
203 ROM
205 RAM
300 Uniform luminance surface
IC Image circle
L Optical axis (of image pickup optical system 3)

1. A method for adjusting an image pickup device, the image pickup device comprising:
an image pickup optical system for forming a subject image;
an image pickup element arranged at an image-forming position of the image pickup optical system and comprising an image pickup surface, for picking up the subject image formed on the image pickup surface by the image pickup optical system; and
a blur correcting mechanism for correcting blur of the subject image formed on the image pickup surface, by moving relative positions of an optical axis of the image pickup optical system and the image pickup element, within a surface perpendicular to the optical axis,
wherein when an image is picked up, a position of the image pickup element is defined based on information of a center position which has been obtained previously, the method for adjusting the image pickup device comprising:
an initial position moving step of moving the position of the image pickup element to an initial position;
an image pickup step of picking up a uniform luminance surface with the image pickup element at the initial position and converting an image of the uniform luminance surface into image signal;
a luminance-distribution calculating step of calculating a luminance distribution on the image pickup surface based on the image signal obtained in the image pickup step;
a center-shift-information calculating step of calculating information of a center shift based on information of the luminance distribution on four corners of the image pickup surface;
a center-agreement judging step of judging whether data of the luminance distribution on the four corners of the image pickup surface almost agree with each other, based on the information of the center shift; and
a center-position-information recording step of obtaining a position of the image pickup element under a condition that the data of the luminance distribution on the four corners of the image pickup surface almost agree with each other, based on a result of the center-agreement judging step, and of recording the position of the image pickup element in the image pickup device as information of a center position.

2. The method for adjusting the image pickup device of claim 1,
wherein the information of the center shift comprises information of a horizontal direction Δx and information of a vertical direction Δy which satisfy the following expressions,
where x₁, x₂, x₃, and x₄ are positions of pixels of the image pickup surface in horizontal rows and are named in order of a clockwise direction from an upper left side as the positions are viewed from a side of the image pickup optical system, wherein the pixels have luminance being smaller than a maximum value of the luminance distribution by a predetermined percentage and are positioned on upper and lower ends of the image pickup surface,
y₁, y₂, y₃, and y₄ are positions of pixels of the image pickup surface in vertical columns and are named in order of a clockwise direction from a upper left side as the positions are viewed from the side of the image pickup optical system, wherein the pixels have luminance being smaller than the maximum value of the luminance distribution by a predetermined percentage and are positioned on right and left ends of the image pickup surface,
Iₓ is a length in the horizontal direction of the image pickup surface, and
I_{y} is a length in the vertical direction of the image pickup surface:
Δx=((x₁+x₃)/2+(x₂+x₄)/2)×½−Iₓ/2,
Δy=((y₁+y₃)/2+(y₂+y₄)/2)×½−I_{y}/2.

3. The method for adjusting the image pickup device of claim 1,
wherein the blur correcting mechanism comprises:
an image-pickup-element moving section for moving the image pickup element within the surface perpendicular to the optical axis; and
an image-pickup-element position sensor for measuring a position of the image pickup element, and
the initial position is a center position of a measuring range of the image-pickup-element position sensor.

4. The method for adjusting the image pickup device of claim 1,
wherein the blur correcting mechanism comprises:
an image-pickup-optical-system moving section for moving a part or whole of the image pickup optical system within the surface perpendicular to the optical axis; and
an image-pickup-optical-system position sensor for measuring a position of the part or whole of the image pickup optical system, and
the initial position is a center position of a measuring range of the image-pickup-optical-system position sensor.

5. The method for adjusting the image pickup device of claim 1,
wherein the initial position is a center value of a data distribution of the center positions which have been obtained previously.

6. An image pickup device comprising:
an image pickup optical system for forming a subject image;
an image pickup element arranged at an image-forming position of the image pickup optical system and comprising an image pickup surface, for picking up the subject image formed on the image pickup surface of the image pickup element;
a blur correcting mechanism for correcting blur of a subject image formed on the image pickup surface, by moving a relative positions of an optical axis of the image-pickup optical system and the image pickup element, within a surface perpendicular to the optical axis; and
a recording section,
wherein the recording section records information of a center position obtained by the method for adjusting the image pickup device of claim 1.
